(19) United States
(12) Patent Application Publication
(10) Pub. No.: US 2016/0177598 A1
(43) Pub. Date: Jun. 23, 2016

(54) LOCKING DEVICE

(71) Applicant: Sennheiser Communications A/S, Ballerup (DK)

(72) Inventors: Christian WANG, Ballerup (DK); Klaus Sommer IPSEN, Ballerup (DK)

(73) Assignee: Sennheiser Communications A/S, Ballerup (DK)

(21) Appl. No.: 14/976,871

(22) Filed: Dec. 21, 2015

(30) Foreign Application Priority Data
Dec. 22, 2014 (EP) 14199573.8

(51) Int. Cl. E05B 73/00

(52) U.S. Cl. CPC E05B 73/0082

(57) ABSTRACT

A locking device for securing a piece of electronic equipment to a structure is disclosed. The locking device comprises one or more mounting structures configured to fix the locking device to the structure. The locking device comprises one or more cable guides configured to receive a cable of the piece of electronic equipment and hereby restrict the range of motion of the piece of electronic equipment. The locking device includes one or more features to prevent the locking device from being unlocked.

### FIELD OF INVENTION

The present disclosure relates to a locking device for securing a piece of electronic equipment, typically with an integrated cable, to a structure such as a tabletop or a wall. More particularly, the disclosure relates a locking device for securing a wired device such as a wired speakerphone to a tabletop or workstation in a manner in which the speakerphone is movably arranged at the tabletop.

### BACKGROUND

Small electronic equipment such as speakerphones is frequently left in common areas such as in meeting rooms. Due to the size of the speakerphones available on the market today, it is most often required to provide some kind of locking equipment in order to prevent someone from “removing” or “borrowing” a speakerphone without bringing it back.

Therefore, several attempts have been made in order to discourage “grab and dash” theft.

One common way of securing electronic equipment is to attach it to the tabletop by means of screws, bolts or double-sided adhesive tape. The main problem associated with this approach is that, once the speakerphone is attached to the tabletop, it cannot be moved. This may cause problems when the position or configuration of the participants in a meeting room changes.

Another common way of securing a piece of equipment, such as a speakerphone, to a tabletop is to lockingly attach the speakerphone to a mounting device (e.g. a “Kensington Security Slot”) configured to receive a security cable or a security lock. The mounting device is typically attached to the equipment by means of double-sided adhesive tape. Once the mounting device is attached to the speakerphone, a compliant security cable or lock can be lockingly attached to the speakerphone.

One major problem associated with these solutions is that if the Kensington Security Lock is loose or contains components that can rattle, it can cause acoustic feedback. Moreover, the cost of the required external security equipment can be significant.

Accordingly, there is a need for an alternative way of securing a piece of equipment such as a speakerphone to a tabletop or another object.

### SUMMARY OF THE INVENTION

Preferred embodiments of the present disclosure can be achieved by a locking device as defined in claim 1. Other preferred embodiments are defined in the dependent sub claims and explained in the following description and illustrated in the accompanying drawings.

According to an aspect of the disclosure, the locking device is an instrument for securing a piece of electronic equipment to a structure, preferably a plate such as a tabletop. The locking device comprises one or more mounting structures configured to fix the locking device to the structure, wherein the locking device comprises one or more cable guides configured to receive a cable mechanically attached to the electronic equipment desired to be secured and hereby restrict the range of motion of the electronic equipment.

Hereby, it is possible to prevent a piece of electronic equipment, such as a speakerphone, from being removed from the room in which it is installed. At the same time the locking device allows the piece of electronic equipment to be moved within a range of motion defined by the length of the cable.

The one or more mounting structures may be any suitable structure configured to fix the locking device to the structure. The attachment may be a permanent attachment comprising any suitable type of fastening hardware including screws, bolts, wires, magnets, glue, or double-sided adhesive tape.

Accordingly, in different embodiments, there may different ways of ways of mounting the locking device (2) to the table top/workspace such as screw/bolt, tape, steel cable/Kensington lock or a combination thereof.

The one or more cable guides may have any suitable size and geometry.

It may be useful that the one or more cable guides are basically cylindrical and have a width (diameter) that is slightly larger than the width (diameter) of the cable intended to be received by the cable guides.

By restricting the range of motion of the piece of electronic equipment, theft can be prevented. However, by maintaining a certain range of motion, the piece of electronic equipment can still be moved within this range of motion. This is particularly useful if the piece of electronic equipment is a speakerphone, projector or web-camera used in a meeting room, in which the configuration of meeting participants frequently changes.

According to another aspect of the disclosure, the cable guide is configured to provide a slidable attachment of at least one cable to the locking device. Hereby, it is possible to increase the range of motion of the piece of electronic equipment.

It is important to ensure that the cable guides have a sufficient diameter and an appropriate geometry corresponding to the geometry of the cable, in order to secure that the cable can move freely within the cable guide.

According to yet another aspect of the disclosure, the locking device comprises a locking structure configured to maintain the locking device in a configuration in which the cable is prevented from being removed from the locking device. Thereby, it is secured that the cable or cables cannot be removed from the locking device.

According to a further aspect of the disclosure, the locking device comprises a security screw configured to prevent the locking device from being opened when the security screw is screwed into the locking device, where the security screw enables the locking device to be opened when the security screw is at least partly unscrewed from the locking device.

In this manner it is possible to use the security screw to prevent the locking device from being unintentionally opened.

According to an even further aspect of the disclosure, the locking device comprises an upper portion and a lower portion configured to be moved relative to each other. When the locking device is configured to be brought into a closed configuration, the cable can only be moved along the cable guide. When the locking device is configured to be brought into an open configuration, the cable can inserted into and be removed from the cable guide while being moved in a direction basically perpendicular to the cable.

Hereby, the cable can be attached to the locking device when the locking device is in the open configuration and the cable is prevented from being removed from the cable guide while being moved in a direction basically perpendicular to the cable (e.g. perpendicular to the longitudinal axis of the cable) within the locking device, thus allowing for the range of motion of the piece of the electronic device.

According to one aspect of the disclosure, the upper portion is rotatably (or configured to be) attached to the lower portion.

By having an upper portion that is rotatably (or configured to be) attached to the lower portion, the locking device can easily be opened and closed. Hereby, it is possible to provide a user-friendly locking device.

According to another aspect of the disclosure, either the upper portion or the lower portion comprises a stationary engagement member configured to receive and lockingly engage with a corresponding movably arranged engagement member of the portion that does not comprise the stationary engagement member.

This type of engagement can be provided by simple mechanical structures that are reliable and cheap to produce.

According to yet another aspect of the disclosure, a canal providing access to the movably arranged engagement member from the outer side of the locking device is provided in the locking device.

Hereby, a pin or another tool can be used to unlock the locking device by inserting the pin or another tool into the canal and moving the movably arranged engagement member into an unlocked position.

The canal may be at least partly formed by a slot e.g. a Kensington Security Slot configured to receive a corresponding locking element (e.g. a key or combination lock). Blocking this canal, for example by attaching a Kensington Lock into the Kensington Security Slot, will prevent a tool from being inserted into the canal. Hereby, the movably arranged engagement member can be prevented from being moved to the unlocked position by the presence of this blocking structure.

According to a further aspect of the disclosure, a support structure is provided next to the movably arranged engagement member, where the support structure is configured to prevent overload of the movably arranged engagement member. Hereby, a simple and reliable overload preventing mechanism can be provided.

The support structure may comprise a plate-shaped member extending parallel or substantially parallel to the engagement member. If the engagement member is pressed towards the support structure, the support structure will function as a stop member bearing against the engagement member and hereby preventing further deflection of the engagement member. Accordingly, the support structure will prevent damage of the engagement member.

According to a further aspect of the disclosure, a security screw can be provided between the support structure and the movably arranged engagement member.

According to a further aspect of the disclosure, the mounting structure comprises a slot configured to receive a corresponding locking element.

Accordingly, it is possible to attach the locking device by means of e.g. a Kensington Security Slot configured to receive a corresponding locking element (e.g. a key or combination lock). The locking element may be attached to a metal wire.

According to a further aspect of the disclosure, the mounting structure comprises a number of recessed portions provided in two opposing sides of the locking device.

Accordingly, a wire may be provided along the recessed portions in such a manner that the wire can be firmly attached to the locking device.

According to a further aspect of the disclosure, the locking device comprises a first cable guide and a second cable guide extending parallel or substantially parallel to the first cable guide.

According to a further aspect of the disclosure the locking device comprises a bore configured for attaching the locking device to a structure. Hereby, the bore can be used to fix the locking device to e.g. a tabletop by means of a screw or bolt.

According to a further aspect of the disclosure, the locking device comprises a first portion and a second portion, where the first portion comprises a protrusion member protruding into a groove of a groove member provided in the second portion.

The groove may preferable be shaped to allow for rotation of the upper portion relative to the lower portion of the locking device about its rotational axis.

### BRIEF DESCRIPTION OF THE DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1A illustrates a perspective view of a locking device according to an embodiment of the disclosure;

FIG. 1B illustrates a perspective view of the locking device shown in FIG. 1A), in a closed configuration;

FIG. 1C illustrates a perspective view of the locking device shown in FIG. 1B), in an open configuration;

FIG. 2A illustrates a cross-sectional view of a locking device according to an embodiment of the disclosure;

FIG. 2B illustrates a perspective cross-sectional view of a locking device shown in FIG. 1A, in a configuration in which a security screw is screwed into the locking device;

FIG. 2C illustrates a perspective cross-sectional view of the locking device shown in FIG. 2A, in a configuration in which a security screw has not been screwed into the locking device;

FIG. 3A illustrates a perspective view of an upper portion of a locking device according to an embodiment of the disclosure;

FIG. 3B illustrates a perspective view of a lower portion of a locking device according to an embodiment of the disclosure;

FIG. 3C illustrates another perspective view of the upper portion shown in FIG. 3A;

FIG. 4A illustrates a perspective view of a locking device according to an embodiment of the disclosure in an open configuration;

FIG. 4B illustrates a how a cable is being slidably attached to the locking device shown in FIG. 4A;

FIG. 4C illustrates the locking device shown in FIG. 4A when a cable has been slidably attached to the locking device;

FIG. 5A illustrates a perspective view of a locking device according to an embodiment of the disclosure seen from below;

FIG. 5B illustrates a perspective view of how to screw a locking device according to an embodiment of the disclosure into a tabletop;

FIG. 6A shows a perspective view of a first locking device according to an embodiment of the disclosure;

FIG. 6B shows a perspective view of a second locking device according to an embodiment of the disclosure;

FIG. 6C shows a perspective view of a third locking device according to an embodiment of the disclosure;

FIG. 6D shows a perspective view of a fourth locking device according to an embodiment of the disclosure;

FIG. 7 shows a locking device according to an embodiment of the disclosure and a speakerphone slidably attached to it and

FIG. 8 shows a perspective top view of a locking device according to an embodiment of the disclosure and a speakerphone slidably attached to it.

### DETAILED DESCRIPTION OF THE INVENTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus are described by various blocks, functional units, modules, components, steps, processes etc. (collectively referred to as “elements”).

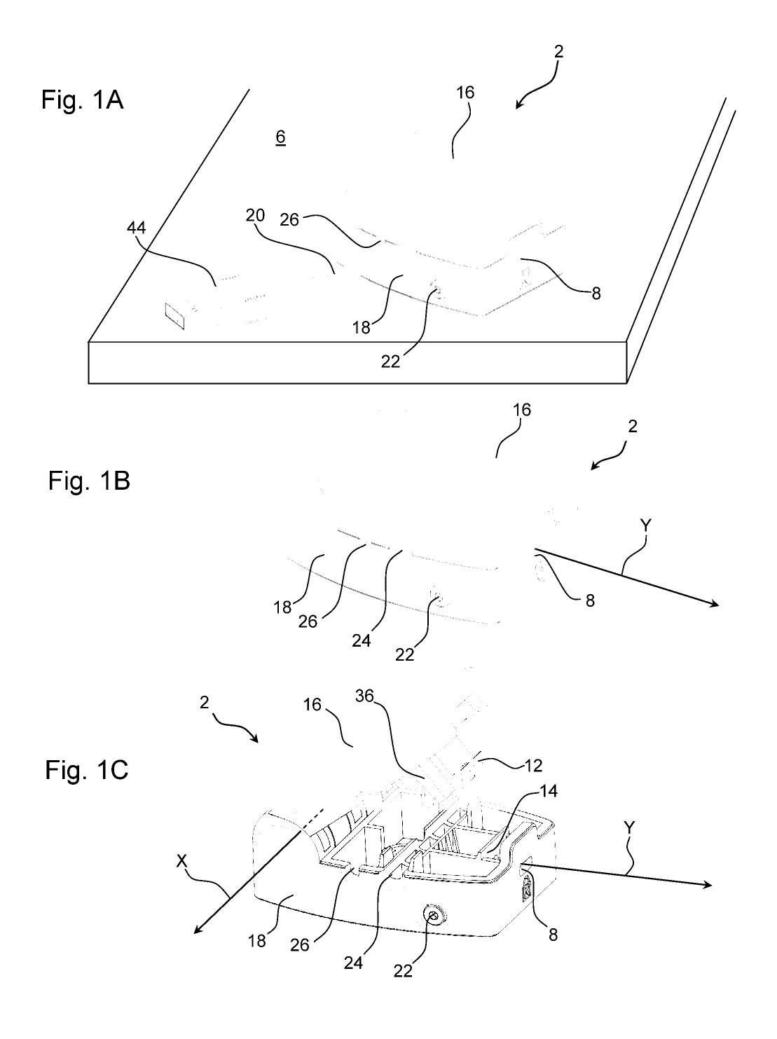

Referring now in detail to the drawings for the purpose of illustrating preferred embodiments of the disclosure, FIG. 1 illustrates perspective views of a locking device 2 according to an embodiment of the disclosure. In FIG. 1A a cable 20 is attached to the locking device 2. In FIG. 1B the cable 20 has been removed. In FIG. 1C the locking device 2 is opened.

The locking device 2 shown in FIG. 1A is an instrument for slidably attachment of a piece of electronic equipment (not shown) having a cable 20. The cable 20 extends through the locking device 2, however; the cable 20 and thus the piece of electronic equipment (not shown) can be moved relative to the locking device 2. The cable 20 extends through a cable guide 24 (see FIG. 1B).

The locking device 2 is attached to a tabletop 6 and therefore, any equipment attached to the locking device 2 by means of a cable 20 can be secured to the tabletop 6.

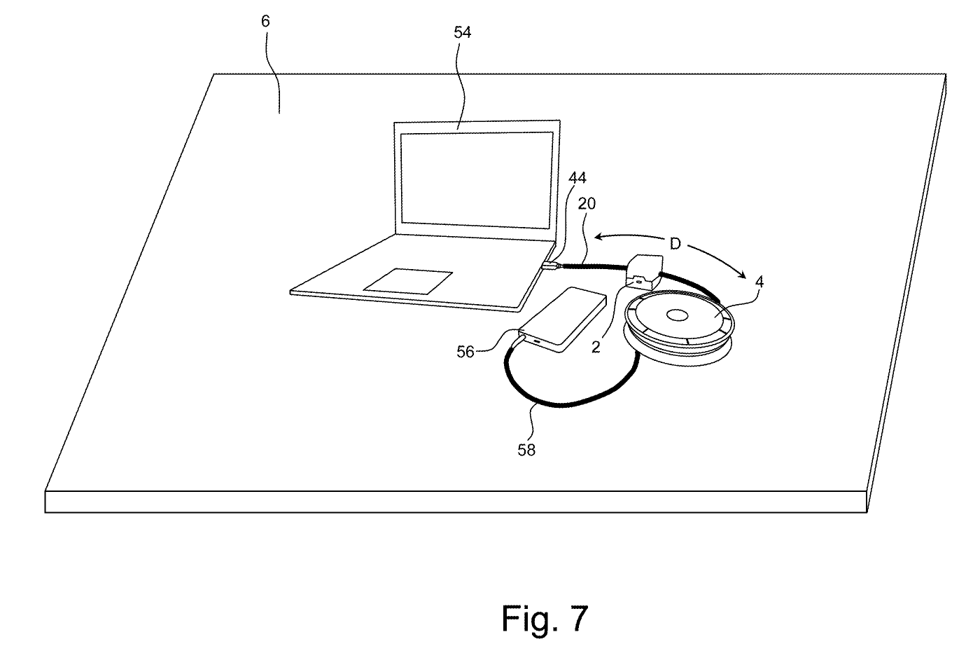

As an example, a Universal Serial Bus (USB) plug 44 is provided in the distal end of the cable 20, however any cable attached to the piece of electronic equipment can be utilized. This USB plug may be attached to a device such as a computer (see FIG. 7).

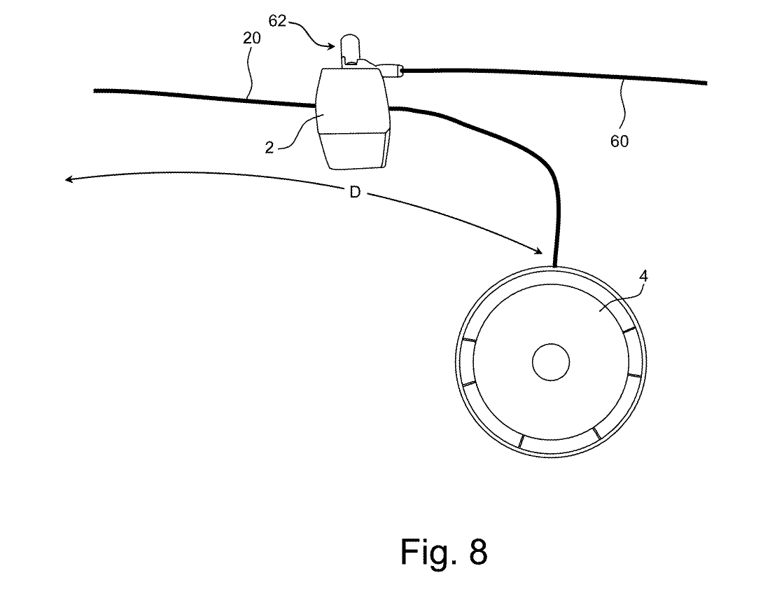

The locking device 2 comprises an upper portion 16 rotatably attached to a lower portion 18. The upper portion 16 or preferably lower portion 18 of the locking device 2 may comprise a mounting structure 8 formed as a slot (e.g. a Kensington Security Slot also referred to as a Kensington lock or K-Slot) configured to receive a corresponding locking element (e.g. a key or combination lock). The locking element (see FIG. 8) may be attached to a metal wire.

The locking device 2 comprises a second cable guide 26 configured to receive a second cable of a device (e.g. a second piece of electronic equipment) that needs to be movably attached to the locking device 2. Although not shown, the locking device 2 may comprise more than the first cable guide 24 (see FIG. 1B) and the second cable guide 26. In another embodiment, the second cable guide 26 may allow a security cable to pass through the second cable guide, with this cable being fixed to a structure. This allows additional locking of the piece of the electronic device comprising the first cable being slidably arranged in the cable guide 24.

The locking device 2 is provided with a security screw 22 for locking the upper portion 16 and the lower portion 18 to each other and to unlock the upper portion 16 and the lower portion 18 from each other, respectively. In the configuration in which the security screw 22 has been screwed fully into the locking device 2, the locking device is locked, so that the upper portion 16 and the lower portion 18 cannot be moved relative to each other.

In FIG. 1B, there is no cable attached to the locking device 2. Accordingly, the first cable guide 24 can be seen more clearly. The first cable guide 24 is centrally arranged and extends perpendicular to the longitudinal axis Y of the locking device 2.

FIG. 1C illustrates the locking device 2 shown in FIG. 1B in an open configuration. The upper portion 16 has been rotated about the rotational axis X of the locking device 2. Thus, the interior of the upper portion 16 and the lower portion 18 of the locking device 2 is visible.

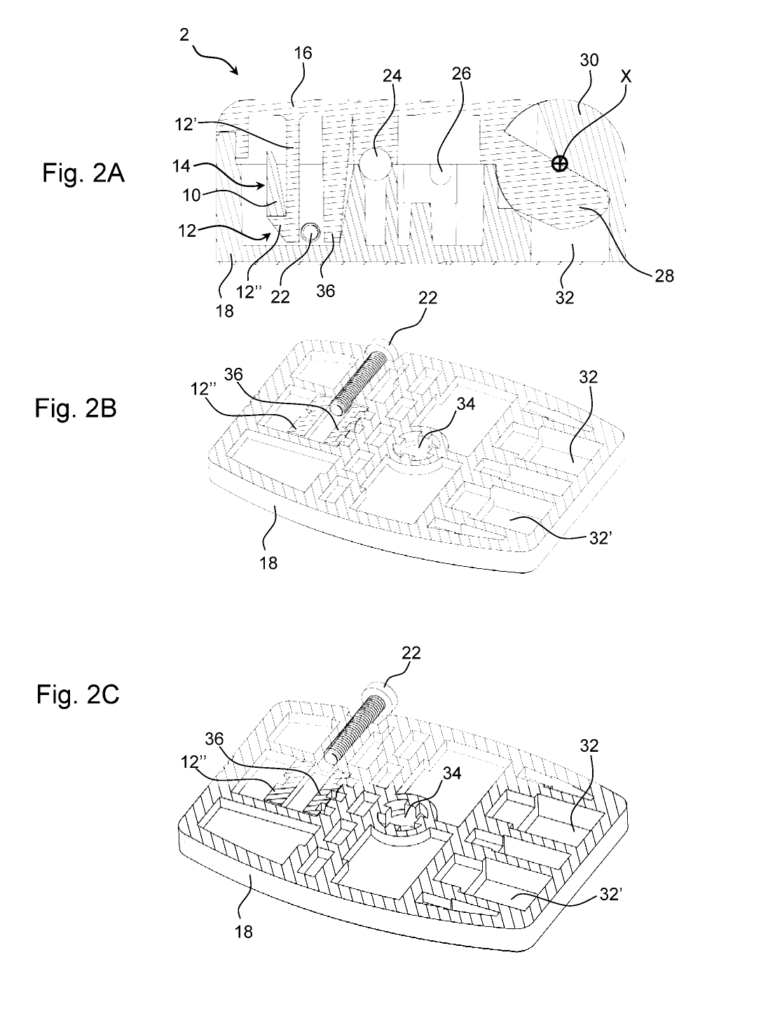

The lower portion 18 of the locking device 2 comprises an attachment structure 14 having a stationary engagement member (see FIG. 2A) configured to receive a corresponding movably mounted engagement member 12 of the upper portion 16.

A support structure 36 is arranged next to the movably mounted engagement member 12 of the upper portion 16. The support structure 36 comprises a plate-shaped member extending parallel or substantially parallel to the engagement member 12. The support structure 36 is configured to prevent overload of the engagement member 12. If the engagement member 12 is pressed towards the support structure 36, the support structure 36 will function as a stop member bearing against the engagement member 12 and hereby preventing further deflection of the engagement member 12. Accordingly, the support structure 36 will prevent damage of the engagement member 12.

The locking device 2 may be produced in any suitable material including plastic materials, metal or wood.

FIG. 2 illustrates three different cross-sectional views of a locking device 2 according to an embodiment of the disclosure.

FIG. 2A illustrates a first cross-sectional view of the locking device 2.

The locking device 2 comprises an upper portion 16 rotatably attached to the lower portion 18 of the locking device 2. The upper portion 16 comprises a protrusion member 28 protruding into a groove 32 of a groove member 30 of the lower portion 18. The groove 32 is shaped to allow for rotation of the upper portion 16 relative to the lower portion 18 of the locking device 2 about the rotational axis X.

The locking device 2 comprises a first through going cable guide 24 typically having a circular cross section. The locking device 2 comprises a second through going cable guide 26 having a U-shaped cross section.

The upper portion 16 of the locking device 2 comprises a movably mounted engagement member 12 having a plate-shaped portion 12′ and an engagement portion 12″ having a triangular cross section. The engagement portion 12″ of the movably mounted engagement member 12 engages a stationary engagement member 10 of the lower portion 18 of the locking device 2. In an implementation, the engagement member 10 and the engagement portion 12″ form a snap lock configuration, with the engagement portion 12″ snap locking into the engagement member 10. Accordingly, the locking device 2 is locked automatically by merely closing the upper portion 16 into the lower portion 18 in snap lock fashion.

The locking device 2 comprises a support structure 36 comprising a plate-shaped member extending parallel or substantially parallel to the plate-shaped portion of the engagement member 12′. The support structure 36 is configured to prevent unintended deflection of the movably mounted engagement member 12.

A security screw 22 extends along the distal portion of the movably mounted engagement member 12 and the distal portion of the support structure 36. When the security screw 22 is provided in this position, the engagement portion 12″ is prevented from being moved towards the support structure 36. Accordingly, while the security screw 22 is provided in this position, the upper portion 16 of the locking device 2 is prevented from being “unlocked” from the lower portion 18 of the locking device 2.

When the security screw 22 is brought out of this position, the upper portion 16 of the locking device 2 is no longer prevented from being unlocked relative to the lower portion 18 of the locking device 2. To “unlock”, however, the movably mounted engagement member 12 must be moved towards the support structure 36 so that the engagement portion 12″ is behind the stationary engagement structure 10 before the upper portion 16 of the locking device 2 can be rotated relative to the lower portion 18 of the locking device 2 in order to open the locking device 2.

FIG. 2B illustrates another cross-sectional view of the locking device 2 shown in FIG. 2A. Only the bottom portion of the lower portion 18 of the locking device 2 can be seen.

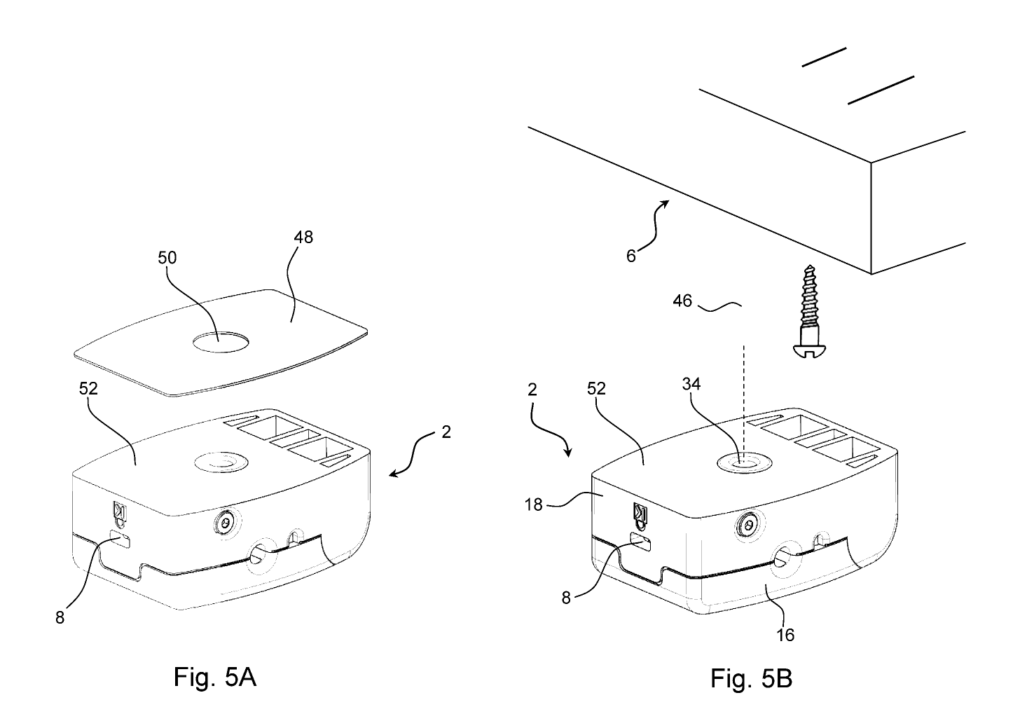

It can be seen that the lower portion 18 of the locking device 2 comprises a first groove 32 and a second groove 32′. The lower portion 18 moreover comprises a bore 34 for fastening the lower portion 18 to an underlying object such as a tabletop (see FIG. 5B).

Since the security screw 22 extends into the space between the engagement portion 12″ (the distal portion of the movably mounted engagement member 12) and the distal portion of the support structure 36, the engagement portion 12″ is prevented from being moved towards the support structure 36. Accordingly, the security screw 22 locks the locking device 2.

FIG. 2C is almost identical to FIG. 2B. In FIG. 2C, however, the security screw 22 has been unscrewed and thus does not extend into the space between the engagement portion 12″ and the distal portion of the support structure 36. Therefore, the engagement portion 12″ is no longer prevented from being moved towards the support structure 36.

Accordingly, unscrewing the security screw 22 unlocks the locking device 2.

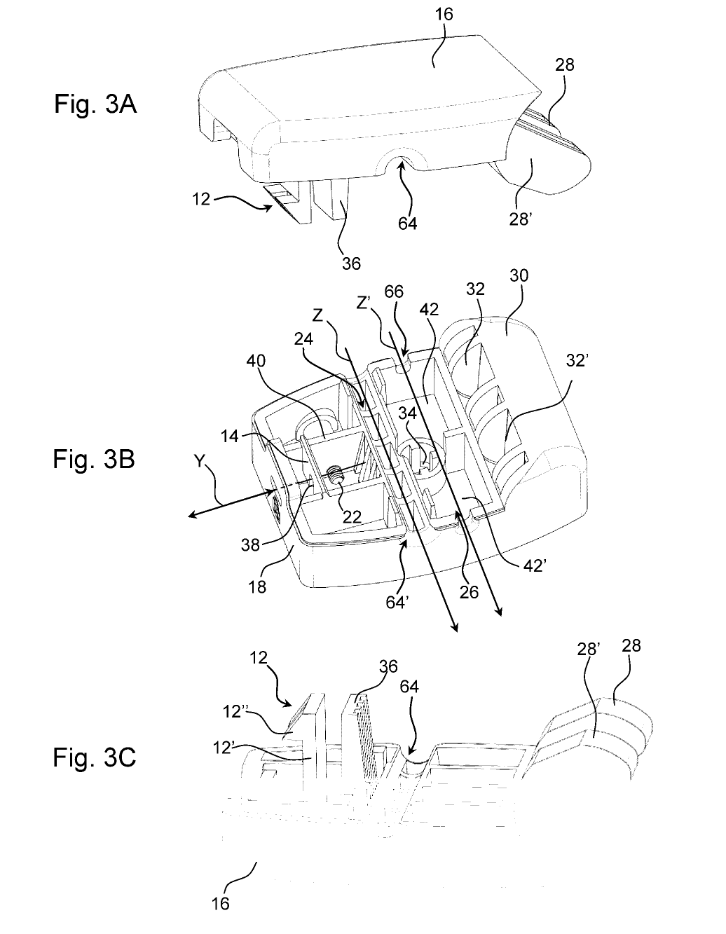

FIG. 3A illustrates a perspective view of an upper portion 16 of a locking device according to an embodiment of the disclosure. The upper portion 16 comprises a flat top portion, two protrusion members, 28, 28′, an engagement member 12 and a support structure 36. A semi-circular structure 64 is provided in the upper portion 16. The semi-circular structure 64 is intended to form a part of the opening through which a cable from the piece of an electronic equipment (e.g. a speaker phone—see FIG. 7 or FIG. 8) attached to the locking device can extend.

The upper portion 16 shown in FIG. 3A is intended for being attached to the lower portion 18 illustrated in FIG. 3B. The lower portion 18 illustrated in FIG. 3B comprises a groove member 30 provided with a first groove 32 and a second groove 32′ configured to receive the protrusion members, 28, 28′ of the upper portion 16 shown in FIG. 3A.

The lower portion 18 further comprises a bore 34 for attachment of the lower portion 18 into a mounting structure such as a tabletop by means of a screw (like illustrated in FIG. 5). The lower portion 18 moreover comprises a first room 42 and a second room 42′ for additional locking features (not shown).

A first cable guide 24 is provided along a first transversal axis Z. A second cable guide 26 is provided along a second transversal axis Z′. The second cable guide 26 is defined by two U-shaped structures 66 provided in the outer wall structure of the lower portion 18.

The lower portion 18 comprises wall member 40 extending along the longitudinal axis Y of the lower portion 18. A security screw 22 is screwed into the space next to the attachment structure 14 of the lower portion 18. An aperture 38 is provided in the attachment structure 14. A pin or another tool (not shown) can be inserted through the aperture 38 in the attachment structure 14 in order to push the movably mounted engagement member 12 of the upper portion 16 in a direction towards the support structure 36 of the upper portion 16.

Accordingly, the locking device can be “unlocked” by using a pin or another tool inserted through mounting structure 8 and aperture 38 to displace the engagement member 12 in a direction towards the support structure 36.

The lower portion 18 comprises a semi-circular portion 64′ that put together with the semi-circular portion 64 of the upper portion 16 constitute a circular opening for the first cable guide 24.

FIG. 3C illustrates another perspective view of the upper portion 18 shown in FIG. 3A. The upper portion 18 comprises two protrusion members, 28, 28′ and an engagement member 12 having a plate-shaped portion 12′ and an engagement portion 12″.

A support structure 36 is provided next to the movably mounted engagement member 12. Further a semi-circular structure 64 is provided in the upper portion 16.

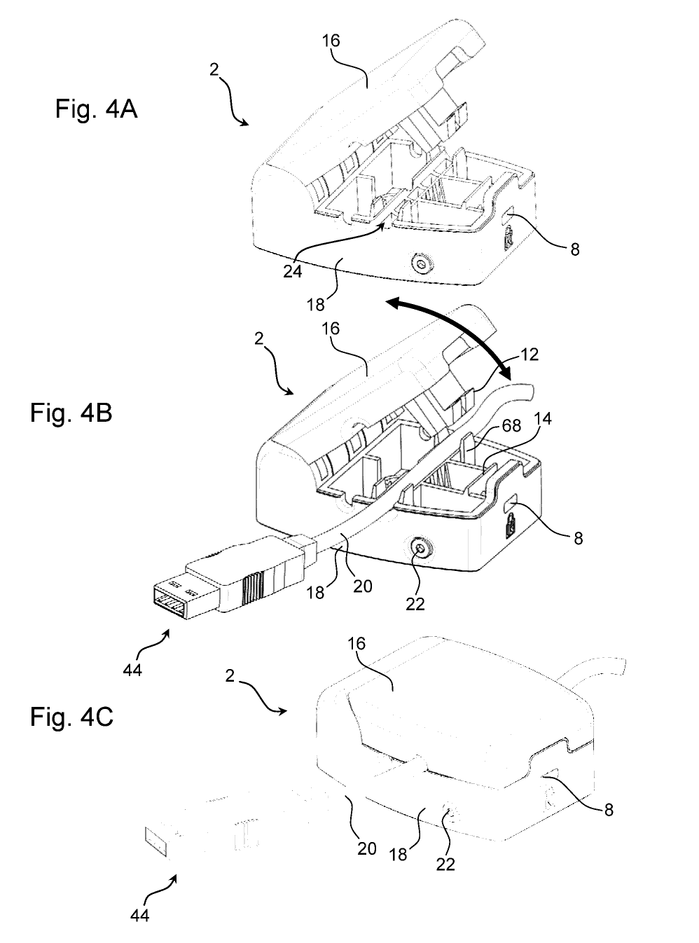

FIG. 4 illustrates how to attach a cable 20 of an electronic device to the locking device 2. The locking device 2 shown in FIG. 4 comprises a lower portion 18 equipped with a mounting structure 8 formed as a slot (e.g. a Kensington Security Slot also referred to as a Kensington lock or K-Slot) configured to receive a corresponding locking element (e.g. a key or combination lock). The locking device 2 comprises a security screw 22 like the one explained with reference to FIG. 2.

In an embodiment, attaching a locking element to the mounting structure 8 blocks access to the movably mounted engagement member 12, through mounting structure 8 and aperture 38, thus preventing it from being “unlocked” by moved towards the support structure 36.

FIG. 4A illustrates a perspective view of a locking device 2 according to an embodiment of the disclosure in an open configuration. This view corresponds to the one shown in FIG. 1C.

FIG. 4B illustrates a how a cable 20 is being slidably attached to the locking device 2 shown in FIG. 4A. The cable 20 is provided in the first cable guide 24 of the locking device 2. The cable 20 is supported by two pairs of support members 68 configured maintain the cable 20 fixed within the cable guide 24.

A connector, such as a Universal Serial Bus (USB) plug 44, is provided at the distal portion of the cable 20. The USB plug may be inserted into a computer or another electronic device (not shown) e.g. configured to provide a signal to a speakerphone (not shown) connected to the proximal end of the cable 20. The connector could also be, for example, a mains power plug, or audio plug if integrated into the equipment.

The locking device 2 comprises an upper portion 16 rotatably mounted to a lower portion 18. The upper portion 16 is provided with a movably mounted engagement member 12 configured to engage with a corresponding attachment structure 14 of the lower portion 18 of the locking device 2.

FIG. 4C illustrates the locking device 2 shown in FIG. 4A in a closed configuration in which a cable 20 has been slidably attached to the locking device 2. The locking device 2 is prevented from being unlocked by means of the security screw 22 that has been screwed into the locking device 2.

FIG. 5 illustrates perspective views of a locking device 2 according to an embodiment of the disclosure seen from below. The locking device 2 corresponds to the one shown in FIG. 4 and comprises an upper portion 16 provided with a mounting structure 8 and a lower portion 18.

The locking device 2 has a backside portion 52 configured to be attached to a structure such as a tabletop 6. A bore 34 is provided in the central portion of the backside portion 52.

A double-sided adhesive tape 48 having a shape corresponding to the geometry of the backside portion 52 provided with a centrally arranged aperture 50 is positioned close to the backside portion 52 of the locking device 2. The double-sided adhesive tape 48 is configured to be attached to the backside portion 52 of the locking device 2 and to a mounting structure such as the tabletop illustrated in FIG. 5B.

It is preferred that the size of the backside portion 52 is large enough to prevent the locking device 2 from being pulled off when taped to a tabletop.

FIG. 5B illustrates a perspective view of how to screw a locking device 2 according to an embodiment of the disclosure into a tabletop 6. The locking device 2 can be fastened to the tabletop 6 by means of a screw 46. The screw 46 must be inserted into the bore 34 in the backside portion of the locking device 2 from inside (see FIG. 2 or FIG. 3 for a view of the inside of the locking device 2).

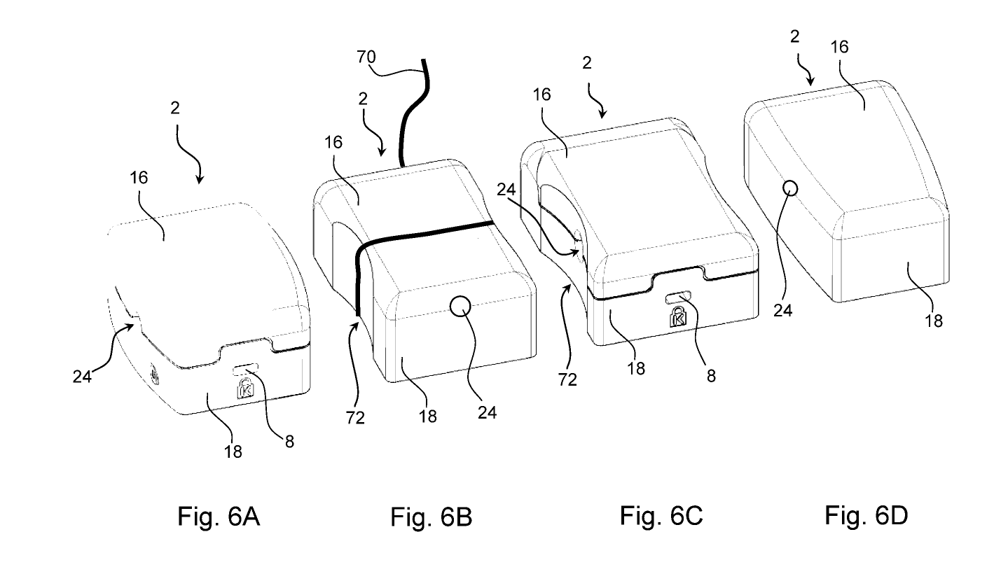

FIG. 6 illustrates perspective views of four different locking devices 2 according to embodiments of the disclosure. The locking devices 2 comprise an upper portion and a lower portion 18.

FIG. 6A illustrates a locking device 2 corresponding to the one shown in FIG. 1-5. The locking devices 2 comprises a thorough going cable guide 24 and a mounting structure 8 formed as a slot.

FIG. 6B shows a perspective view of second locking device 2 according to an embodiment of the disclosure. The locking device 2 comprises recessed portions 72 provided in two opposing sides of the locking device 2. A wire 70 extends along the recessed portions 72 in such a manner that the wire 70 is firmly attached to the locking device 2. A cable guide 24 extends through the locking device 2.

The locking device 2 may alternatively be fixed to a mounting structure (e.g. a tabletop) by means of a screw or double-sided adhesive tape. In this case the wire 70 will function as a security wire 70.

FIG. 6C illustrates a perspective view of another locking device 2 according to an embodiment of the disclosure. The locking device 2 is provided with recessed portions 72 provided in two opposing sides of the locking device 2. The locking devices 2 comprises a thorough going cable guide 24 and a mounting structure 8 formed as a slot. The recessed portions 72 may be applied to fasten the locking device 2 to a wire like illustrated in FIG. 6B.

FIG. 6D illustrates a perspective view of a further locking device 2 according to an embodiment of the disclosure. The locking device 2 comprises a thorough going cable guide 24.

The locking device 2 may comprise two portions rotatably attached to each other or two portions configured to be entirely separated from each other when attaching a cable into the locking device 2. The cable guide 24 is required to have a diameter and shape (rounded edges) allowing for the cable to be freely within it.

FIG. 7 illustrates a locking device 2 according to an embodiment of the disclosure and a speakerphone 4 slidably attached to it. The speakerphone 4 comprises a first cable 20 electrically connected to a computer 54 by means of a USB plug 44 provided at the distal end of the cable 20. The speakerphone 4 comprises a second cable 58 electrically connected to a phone 56.

The locking device 2 is attached to a tabletop 6. Accordingly, although the cable 20 can be moved along the cable guide (see FIG. 1-4) of the locking device 2, the speakerphone 4 cannot be removed from the tabletop 6. The range of motion of the cable 20 relative to the locking device 2 is indicated with arrow D indicating a distance. Accordingly, the locking device 2 allows for moving the speakerphone 4 in order to position the speakerphone 4 in the most appropriate position at the tabletop 6.

The locking device 2 can be used in many scenarios. IT managers for small-to-medium businesses to large enterprises with one or more shared meeting rooms. The speakerphones 4 would be secured either directly to the meeting room tables 6, to the wall (if table is against the wall), or to the underside of the tabletop 6 to a leg or adhesive anchor (with a flexible cable).

FIG. 8 illustrates a perspective top view of a locking device 2 according to an embodiment of the disclosure and a speakerphone 4 slidably attached to the locking device 2. The locking device 2 is attached to a wire 60 by means of a locking element 62 fixed to mounting structure 8 of the locking device 2.

The speakerphone 4 is slidably attached to the locking device 2 by means of a cable 20 extending through a cable guide going through the locking device 2. Thus, the cable 20 has a range of motion indicated by the arrow D. By having a speakerphone 4 being slidably attached to the locking device 2, it is possible to move the speakerphone 4 and still prevent it from being removed or borrowed without bringing it back.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

### LIST OF REFERENCE NUMERALS

2 Locking device

4 Electronic equipment

6 Tabletop

8 Mounting structure

10 Stationary engagement member

12 Movably mounted engagement member

12′ Plate-shaped portion

12″ Engagement portion

14 Attachment structure

16 Upper portion

18 Lower portion

20 Cable

22 Security screw

24, 26 Cable guide

28, 28′ Protrusion member

30 Groove member

32, 32′ Groove

34 Bore

36 Support structure

38 Aperture

40 Wall member

42, 42′ Room

44 Universal Serial Bus (USB) plug

46 Screw

48 Double-sided adhesive tape

50 Aperture

52 Backside portion

54 Computer

56 Phone

58 Cable

60 Wire

62 Locking element

64, 64′ Semi-circular structure

66 U-shaped structure

68 Support member

70 Wire

72 Recessed portion

X, Y, Z, Z′ Axis

D Distance

1. A locking device for securing a piece of electronic equipment to a structure, preferably a plate such as a tabletop, the locking device comprising one or more mounting structures configured to fix the locking device to the structure, wherein the locking device comprises one or more cable guides configured to receive a cable mechanically attached to electronic equipment and hereby restrict the range of motion of the piece of electronic equipment.

2. A locking device according to claim 1, wherein the cable guide is configured to provide a slidable attachment of at least one cable to the locking device.

3. A locking device according to claim 1, wherein the locking device comprises a locking structure configured to maintain the locking device in a configuration in which the cable is prevented from being removed from the locking device.

4. A locking device according to claim 1, wherein the locking device comprises a security screw configured to prevent the locking device from being unlocked when the security screw is screwed into the locking device, where the security screw enables the locking device to be unlocked when the security screw is at least partly unscrewed from the locking device.

5. A locking device according to claim 1, wherein the locking device comprises an upper portion and a lower portion configured to be moved relative to each other, where the locking device is configured to be brought into a closed configuration in which the cable can only be moved along the cable guide, where the locking device is configured to be brought into an open configuration in which the cable can inserted into and be removed from the cable guide while being moved in a direction basically perpendicular to the cable.

6. A locking device according to claim 1, wherein the upper portion is rotatably attached to the lower portion.

7. A locking device according to claim 1, wherein either the upper portion or the lower portion comprises a stationary engagement member configured to receive and lockingly engage with a corresponding movably arranged engagement member of the portion that does not comprise the stationary engagement member.

8. A locking device according to claim 1, wherein a canal providing access to the movably arranged engagement member from the outer side of the locking device is provided in the locking device.

9. A locking device according to claim 1, wherein a support structure is provided next to the movably arranged engagement member, where the support structure is configured to prevent overload of the movably arranged engagement member.

10. A locking device according to claim 1, wherein a security screw is provided between the support structure and the movably arranged engagement member.

11. A locking device according to claim 1, wherein the mounting structure comprises a slot configured to receive a corresponding locking element.

12. A locking device according to claim 1, wherein attaching the locking element to the mounting structure blocks access, through a canal, that provides access to the movably arranged engagement member from the outer side of the locking device and is provided in the locking device, to the movably mounted engagement member, thereby preventing the locking device from being unlocked.

13. A locking device according to claim 1, wherein the mounting structure comprises a number of recessed portions provided in two opposing sides of the locking device.

14. A locking device according to claim 1, wherein the locking device comprises a first cable guide and a second cable guide extending parallel or substantially parallel to the first cable guide.

15. A locking device according to claim 1, wherein the locking device comprises a bore configured for attaching the locking device to a structure.

16. A locking device according to claim 1, wherein the locking device comprises a first portion and a second portion, where the first portion comprises a protrusion member protruding into a groove of a groove member provided in the second portion.

17. A locking device according to claim 2, wherein the locking device comprises a locking structure configured to maintain the locking device in a configuration in which the cable is prevented from being removed from the locking device.

18. A locking device according to claim 2, wherein the locking device comprises a security screw configured to prevent the locking device from being unlocked when the security screw is screwed into the locking device, where the security screw enables the locking device to be unlocked when the security screw is at least partly unscrewed from the locking device.

19. A locking device according to claim 3, wherein the locking device comprises a security screw configured to prevent the locking device from being unlocked when the security screw is screwed into the locking device, where the security screw enables the locking device to be unlocked when the security screw is at least partly unscrewed from the locking device.

20. A locking device according to claim 2, wherein the locking device comprises an upper portion and a lower portion configured to be moved relative to each other, where the locking device is configured to be brought into a closed configuration in which the cable can only be moved along the cable guide, where the locking device is configured to be brought into an open configuration in which the cable can inserted into and be removed from the cable guide while being moved in a direction basically perpendicular to the cable.
